(19) United States
(12) Patent Application Publication
(10) Pub. No.: US 2007/0046655 A1
(43) Pub. Date: Mar. 1, 2007

(54) Simplified interface for dialog between a user and an interactive terminal, and interacttive terminal provided with said interface

(76) Inventor: Margust Bruno, Besancon (FR)

Correspondence Address: SOFER & HAROUN LLP., 317 MADISON AVENUE, SUITE 910, NEW YORK, NY, 10017, US

(21) Appl. No.: 10/547,663

(22) PCT Filed: Mar. 29, 2004
(86) PCT No.: PCT/FR04/00793

§ 371 Date: Aug. 31, 2005

(30) Foreign Application Priority Data
Mar. 31, 2003 (FR) 03/03984

(51) Int. Cl. G09G 5/00

(52) U.S. Cl. 345/184

(57) ABSTRACT

The invention relates to an interface (12) for dialogue between a user and an interactive terminal (10), especially a parking meter for a motor vehicle, comprising at least one selection element (30) enabling the user to choose the value of at least one parameter from an associated list of values, a validation element (30) enabling the user to validate his or her choice, a canceling element (32) enabling the user to cancel a choice, and a display screen (16) enabling the user to visualize the value of the parameter, wherein the interactive terminal (10) performs an operation which is determined according to the choice of the parameter, characterized in that the selection element (30) also forms the validation element.

The invention relates to an interface for dialog between a user and an interactive terminal or automaton delivering goods or services, especially a parking meter for a motor vehicle.

More particularly, the invention relates to an interface for dialog between a user and an interactive terminal or automaton delivering goods or services, especially a parking meter for a motor vehicle or a travel ticket dispenser, etc. The terminal comprises at least one selection element enabling the user to choose the value of at least one parameter from an associated list of values, a validation element enabling the user to validate his or her choice, a canceling element enabling the user to cancel a choice, and a display screen enabling the user to visualize the value of the parameter and is of the type wherein the terminal is interactive and performs an operation which is determined according to the choice of the parameter, such as the delivery of the goods or the service corresponding to the user's selection.

This type of interactive terminal finds a general application to paying to park a motor vehicle, more particularly to park a motor vehicle on the highway or in a car park. These interactive terminals are also known as parking meters.

One type of prior art parking meter includes a dialog interface enabling the user to define various parameters, for example the duration of parking, as a function of which the parking meter calculates a charge that the user must pay to obtain the authorization to park. The charge to be paid is communicated to the user by means of a screen, for example.

To accept the user's payment, the parking meter includes payment elements. In one prior art design the mode of payment constitutes an additional parameter to be defined by the user by means of the control interface. The user may choose to pay by means of a bank card or by means of coins, for example.

In exchange for the payment, the parking meter delivers an authorization to park, for example a printed ticket. The ticket carries in particular a time and date at which the authorization to park expires. The user must then place this ticket somewhere visible in the vehicle, for example behind the windshield.

The parking meter can also issue free of charge a ticket indicating until when free parking is authorized.

The operations whereby the user obtains the ticket authorizing parking are referred to as a transaction in the remainder of the description.

In the prior art, other parameters may be asked for during the dialog between the user and the interactive terminal. The user may choose the language in which information is displayed on the screen, for example.

In the above designs, the dialog interface includes selection buttons that the user employs to select the value of each parameter. The interface comprises as many selection buttons as there are parameters to be defined. It further includes a validation button enabling the user to validate his choices and a cancel button enabling the user to cancel his choices.

When using this kind of parking meter, the user first selects a first parameter by means of a first selection button. The screen displays the value selected for the first parameter, after which the user presses the validation button to validate the value selected for the first parameter. The user repeats this operation for each of the parameters.

If the user wishes to cancel one of his choices, he presses the button corresponding to the parameter to be canceled and then presses the cancel button.

When all the parameters have been set, the user confirms them to the terminal by pressing the validation button a final time. The screen then displays the charge to be paid to obtain the authorization to park. The user inserts money into the terminal and in exchange receives the printed ticket.

However, the multiplicity of buttons makes this kind of parking meter complicated to use and not very ergonomic. The user wastes time identifying the various commands distributed over the dialog interface.

To solve this problem, the present invention proposes a simplified dialog interface of the type described above that is characterized in that the selection element also forms the validation element.

According to other features of the invention:
the user is able to select the value of at least two parameters and the interface includes a single selection element common to all the parameters;
the selection element is an indexed knob that is mounted to rotate about a rotation axis and is mounted to slide along a sliding axis, rotating it selecting the value of a parameter and sliding it validating the selection;
the sliding axis and the rotation axis of the knob are the same;
the knob includes a central orifice accommodating the selection canceling element;
the cancelation element is a pushbutton whose sliding axis and the rotation axis of the knob are the same;
the knob includes means for indexing its angular position relative to the terminal;
each indexed angular position of the knob corresponds in a predetermined manner to a value of a parameter;
a list of the values of each parameter is displayed on the screen and the movement of the knob from one angular position to another commands the movement of a value selection cursor;
the selection knob is under the screen;
the rotation axis of the knob is globally orthogonal to the front face of the interactive terminal.

The invention also relates to an interactive terminal, especially a parking meter for motor vehicles, characterized in that it includes an interface for dialog with a user according to any one of the preceding claims.

Other features and advantages of the invention will become apparent in the course of reading the following detailed description, to assist with an understanding of which reference should be had to the appended drawings, in which:

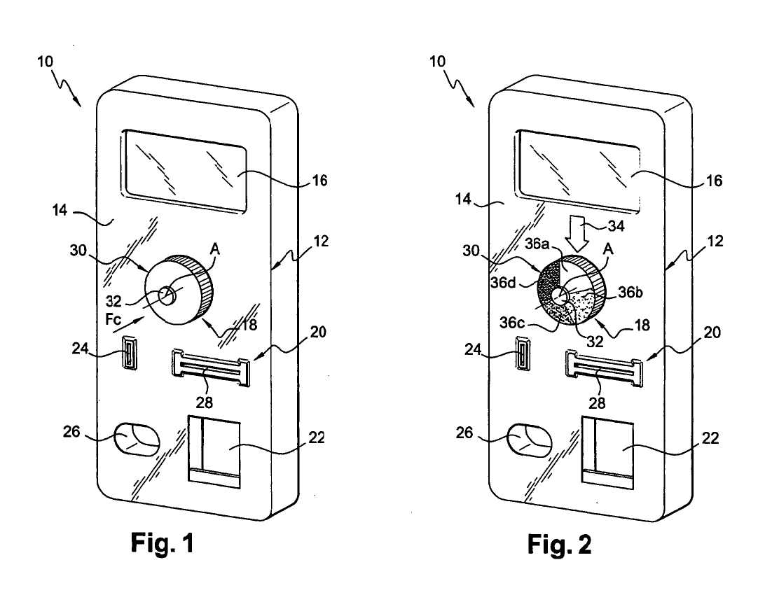

FIG. 1 is a perspective view showing diagrammatically an interactive terminal including a first embodiment of a dialog interface of the invention, and

FIG. 2 is a view similar to that of FIG. 1, showing a second embodiment of the invention.

FIG. 1 represents an interactive terminal 10. Here the terminal 10 is a parking meter.

The interactive terminal 10 includes an interface 12 for dialog between the user and the terminal 10. The interface 12 takes the form of a vertical transverse wall 14 on which are arranged information communication elements 16, parameter selection elements 18, payment elements 20 and a ticket dispenser 22.

As in the prior art, the communication elements 16 include a screen at the top. The screen 16 displays information concerning the transaction.

The payment elements 20 include a vertical slot 24 for inserting coins. The user is therefore able to pay for the parking ticket by inserting coins into the slot 24. A cup 26 below the slot 24 returns change to the user if he or she does not have the exact amount.

The interface 12 includes a horizontal slot 28 for inserting a payment card, for example a bank card (not shown).

Here the ticket dispenser 22 for issuing printed tickets that authorize parking is below the horizontal slot 28.

According to the teaching of the invention, the selection elements 18 include an annular knob 30 for selecting the values of the parameters. The knob 30 lies generally in a plane parallel to the wall 14, under the screen 16.

The knob 30 is mounted so that it can rotate relative to the wall 14 about its central longitudinal axis A. It includes indexing means (not shown) for indexing its angular position relative to the interface 12.

The knob 30 is also mounted so that it can slide in the direction of its rotation axis A between a depressed, forward position (in the direction of the arrow Fc) in which it triggers a validation function and a rest, rearward position toward which it is spring-loaded.

The annular knob 30 includes a central orifice accommodating a pushbutton 32 that is mounted so that it can slide along the rotation axis A of the knob 30. The pushbutton 32 triggers a cancel function when it is depressed forwardly (in the direction of the arrow Fc).

The knob 30 and the pushbutton 32 are independent of each other, i.e. when the user turns or presses the knob 30, the pushbutton 32 remains immobile. Conversely, pressing the pushbutton 32 does not cause any movement of the knob 30.

The operation of the above kind of interactive terminal 10 is described next.

The screen 16 advantageously displays instructions to guide the user through the transaction.

During a first operation of selecting the value of a parameter, the terminal 10 prompts the user, via the screen 16, to select the value of a first parameter, for example the required duration of parking. The screen 16 displays a list of possible values for the first parameter. A cursor (not shown) that is displayed on the screen 16 indicates the selected value.

The user may move the cursor from one value to another by turning the knob 30 about the axis A. The cursor scrolls through the list in a predefined order in a first direction or in a second direction as a function of the clockwise or counterclockwise direction of rotation of the knob 30. Thus movement from one indexed angular position of the knob 30 to the next indexed angular position moves the cursor from one value of the list of values to the next value.

When the screen 16 is displaying the list of values of the parameter, the cursor always selects a default value that is independent of the indexed angular position of the knob 30. The knob 30 merely moves the cursor. Each angular position does not correspond to a predetermined value of a parameter.

When the user has selected the required value, he validates his choice by pressing the knob 30 in the direction of the axis A. The terminal 10 then retains in memory the value of the first parameter, after which it offers a second list of values corresponding to a second parameter, for example the mode of payment: coins or bank card. The user then repeats the operation, again using the knob 30 to select and validate the required value of each subsequent parameter.

If the user wishes to cancel the value of the preceding parameter, he presses the central pushbutton 32. The screen 16 then prompts him to choose a new value for the preceding parameter.

In one variant, pressing the cancel pushbutton 32 cancels the transaction, i.e. all of the parameters are reset.

When all the parameters have been set, the screen 16 prompts the user to validate his selections by pressing the knob 30 again.

In the conventional way, the user may then pay by means of the payment elements 20. In exchange for the payment, the dispenser 22 issues the ticket authorizing parking.

In a second embodiment of the invention, shown in FIG. 2, each indexed angular position of the knob 30 corresponds to a predetermined value of a parameter. All the values of all the parameters are therefore associated with respective indexed angular positions of the knob 30.

To this end, the wall 14 of the interface 12 includes a pointer 34 that is used to select the required value of one of the parameters.

The values associated with a parameter are advantageously distributed in a common angular sector 36. The knob 30 is divided into as many angular sectors 36 as there are parameters. Each parameter can therefore be indicated by an angular sector 36, for example by a different color of the angular sector 36. In the embodiment shown in FIG. 2, the knob 30 comprises four angular sectors 36a, 36b, 36c, 36d.

When the user wishes to select a parameter, he turns the knob 30, one way or the other, to move the angular sector 36 into line with the pointer 34. The user then turns the knob 30 to bring the indexed angular position corresponding to the required value of said parameter into line with the pointer 34. The value may be displayed on the screen 16, for example, or indicated directly on the knob 30. To validate his selection, the user then presses the knob 30. The same operation is then effected for each parameter.

Thanks to this kind of interface, the user can perform all of the transaction using only two control elements. The learning curve for using the interface is therefore considerably reduced.

1. An interface for dialog between a user and an interactive terminal delivering goods or services, especially a parking meter for a motor vehicle, comprising:
at least one selection element enabling the user to choose the value of at least one parameter from an associated list of values;
a validation element enabling the user to validate his or her choice;
a canceling element enabling the user to cancel a choice; and
a display screen enabling the user to visualize the value of the parameter, and of the type wherein the interactive terminal performs an operation which is determined according to the choice of the parameter, wherein the selection element also forms the validation element.

2. Interface according to claim 1, wherein the user is able to select the value of at least two parameters and it includes a single selection element common to all the parameters.

3. Interface according to claim 1, wherein the selection element is an indexed knob that is mounted to rotate about a rotation axis (A) and is mounted to slide along a sliding axis (A), rotating it selecting the value of a parameter and sliding it validating the selection.

4. Interface according to claim 3, wherein the sliding axis (A) and the rotation axis of the knob are the same.

5. Interface according to claim 4, wherein the knob includes a central orifice accommodating the selection canceling element.

6. Interface according to claim 1, wherein the cancellation element is a pushbutton whose sliding axis (A) and the rotation axis of the knob are the same.

7. Interface according to claim 3, wherein the knob includes means for indexing its angular position relative to the terminal.

8. Interface according to claim 7, wherein each indexed angular position of the knob corresponds in a predetermined manner to a value of a parameter.

9. Interface according to claim 7, wherein a list of the values of each parameter is displayed on the screen and the movement of the knob from one angular position to another commands the movement of a value selection cursor.

10. Interface according to claim 3, wherein the selection knob is under the screen

11. Interface according to claim 3, wherein the rotation axis (A) of the knob is globally orthogonal to the front face of the interactive terminal.

12. Interactive terminal, especially a parking meter for motor vehicles, wherein it includes an interface for dialog with a user according to claim 1.
